(19) United States
(12) Patent Application Publication
(10) Pub. No.: US 2008/0234007 A1
(43) Pub. Date: Sep. 25, 2008

(54) Mobile communication terminal for providing backgroud picture during communication

(75) Inventor: Jin-Ho Lee, Seoul (KR)

Correspondence Address: ROTHWELL, FIGG, ERNST & MANBECK, P.C., 1425 K STREET, N.W., SUITE 800, WASHINGTON, DC, 20005, US

(73) Assignee: Seecom International Co., Ltd., Seoul (KR)

(21) Appl. No.: 11/783,340

(22) Filed: Apr. 9, 2007

(30) Foreign Application Priority Data
Feb. 26, 2007 (KR) 10-2007-0019181

(51) Int. Cl. H04B 1/38

(52) U.S. Cl. 455/566

(57) ABSTRACT

A mobile communication terminal provides a still or motion picture as a background picture during communication to allow the terminal to perform voice communication with a counterpart terminal using a stored background picture. In the terminal, a memory stores at least one background picture, each including a picture signal corresponding to a respective user input. A multi-codec converts the background picture and a communication voice and a mixing unit mixes the background picture with the communication voice. A wireless transceiver wirelessly transmits the mixed background picture and communication voice. An output unit outputs the mixed background picture and communication voice. A central processing unit selects, controls, and transmits a background signal according to the user input.

### CROSS REFERENCE TO RELATED APPLICATION

This application also claims priority under 35 U.S.C. § 119 based on Korean Patent Application No. 10-2007-0019181 filed Feb. 26, 2007, which is incorporated herein in its entirety.

### BACKGROUND OF THE INVENTION

1. Field of the Invention

The present invention relates to a mobile communication terminal for providing a still or motion picture as a background picture during communication to allow the terminal to perform voice communication with a counterpart terminal using a stored background picture.

2. Description of the Related Art

A conventional communication background music service is a service that provides music, sound effects, and the like as a voice communication background when calling and called terminals connected to a wired/wireless communication network perform voice communication. Here, the terms “calling and called terminals” refer to terminals that originate and receive a call, respectively.

The conventional communication background music service is provided, for example by a so-called background music service provision device coupled to a Mobile Switching Center (MSC) that manages calling or called terminals on a mobile communication network.

On the other hand, the spread of small high-performance wired/wireless terminals has significantly increased due to the recent rapid development of the electronic communication field. To allow wired/wireless terminals to use communication background music to meet the needs in such environments, Korean Patent Application No. 10-2001-0025155, filed on May 9, 2001 and later granted, suggested a method for transmitting background music during communication with a mobile communication terminal.

FIG. 1 is a flow chart of a conventional method for transmitting background music during communication with a mobile communication terminal.

First, at step S11, a Central Processing Unit (CPU) (not shown) installed in the mobile communication terminal allows the user to select a phone number of each individual or group for background music to be added when communication is established. In this case, the user can specify background music to be added when communication is established on a communication time zone basis and on a communication count (or frequency) basis.

Then, at step S13, the CPU allows the user to select background music to be match the phone number selected at step S11.

Then, at step S15, the CPU stores the phone number selected at step S11 and the background music selected at step S13 in a memory.

Then, at step S17, the CPU determines whether or not communication has been initiated. When communication has been initiated, the CPU proceeds to step S19 to determine whether or not background music matching the calling or called phone number is present in the memory.

If it is determined at step S19 that the matching background music is present, the CPU proceeds to step S21 to determine whether or not it has received an input to use the background music set to match the calling or called phone number.

If it is determined at step S21 that it has received an input to use the set background music, the CPU proceeds to step S23 to perform voice coding of the background music through a signal processor (not shown).

Then, at step S25, the CPU transmits the voice-coded background music together with communication voice to a counterpart terminal through an antenna.

On the other hand, if it is determined at step S19 that no matching background music is present or if it is determined at step S21 that it has not received an input to use the set background music, the CPU proceeds to step S29 to perform voice communication alone.

In the conventional method for providing background music during communication, background music matching the calling or called phone number is output to a communication path between the calling and called terminals. Using this conventional method, the user can perform voice communication incorporating background music rather than the monotonous voice communication.

However, in the conventional method for providing background music during communication using a mobile communication terminal, it is not possible for the user to more actively express their personality through the communication background music since only one preset piece of communication background music, previously stored in the terminal when it was shipped, is transmitted to the communication path when communication is initiated. It is also not possible to change or control a variety of pieces of communication background music. To overcome these problems, the present applicant filed Korean Patent Application No. 10-2003-0042704 on Jun. 27, 2003, which was later granted. This suggested a method for providing communication background sound with a personal portable terminal. This method ensures that a variety of pieces of background music stored in a mobile communication terminal, which were downloaded from a background music service provision device connected to a mobile communication network, can be used as communication background music when communication has been established with a counterpart terminal.

However, this communication background sound provision method is also not rich in diversity in expressing personality or providing entertainment since background music data including audio data alone is transmitted to the communication path when voice communication is performed.

### SUMMARY OF THE INVENTION

Therefore, the present invention has been made in view of the above problems, and it is an object of the present invention to provide a mobile communication terminal for providing a background picture during communication, the mobile communication terminal comprising a memory for storing at least one background picture, each including a picture signal corresponding to a respective user input, using a background picture control program running on the mobile communication terminal; a multi-codec for converting the background picture and a communication voice; a mixing unit for mixing the background picture with the communication voice; a wireless transceiver for wirelessly transmitting the mixed background picture and communication voice; an output unit for outputting the mixed background picture and communication voice; and a central processing unit for selecting, controlling, and transmitting a background signal according to the user input.

It is another object of the present invention to provide a method for providing a background signal using a mobile communication terminal wherein, when both calling and called mobile communication terminals have a background signal provision function, only one of the two terminals, determined according to their preset priority levels, transmits a background signal during communication so that both the calling and called terminals use the same communication background signal.

In accordance with the present invention, the above and other objects can be accomplished by the provision of a mobile communication terminal for providing a background picture during communication, the terminal comprising a memory for storing at least one background picture, each including a picture signal corresponding to a respective user input; a multi-codec for converting the background picture and a communication voice; a mixing unit for mixing the background picture with the communication voice; a wireless transceiver for wirelessly transmitting the mixed background picture and communication voice; an output unit for outputting the mixed background picture and communication voice; and a central processing unit for selecting, controlling, and transmitting a background signal according to the user input.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a flow chart of a conventional method for transmitting background music during communication with a mobile communication terminal;

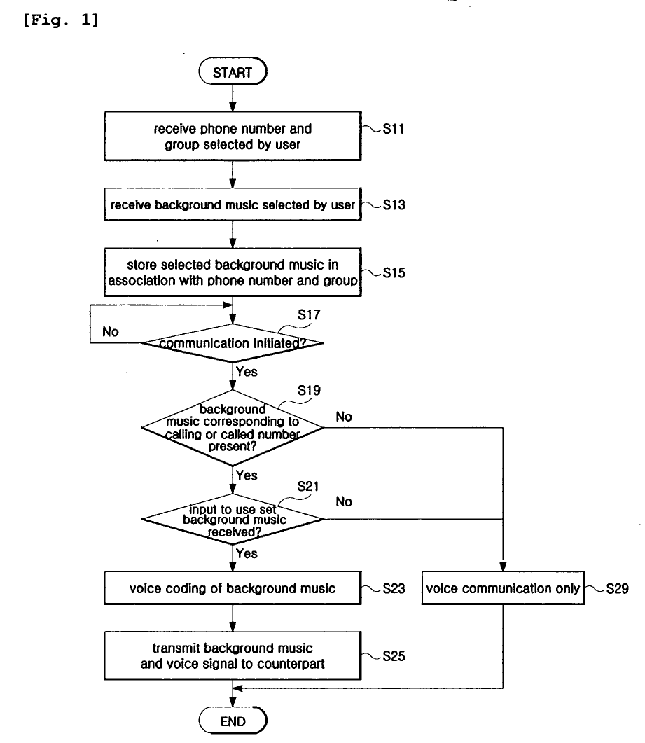

FIG. 2 illustrates the structure of a network to which a mobile communication terminal for providing a background picture during communication according to an embodiment of the present invention is applied;

FIG. 3 is an electrical block diagram of a mobile communication terminal that can be applied to the present invention;

FIG. 4 is a flow chart of a method for downloading a communication background picture according to an embodiment of the present invention;

FIG. 5 is a flow chart of a method for setting a background picture in the mobile communication terminal according to an embodiment of the present invention; and

FIG. 6 is a flow chart of a procedure for communication using a background picture according to an embodiment of the present invention.

### DESCRIPTION OF THE PREFERRED EMBODIMENTS

A mobile communication terminal for providing a background picture during communication according to preferred embodiments of the present invention will now be described in detail with reference to the accompanying drawings. In the description, the term “background signal” is defined to include a still picture, a motion picture, sound source data, and the like. The term “background picture” is basically used to describe a still or motion picture and the term “background sound” is used to describe sound source data alone without picture data.

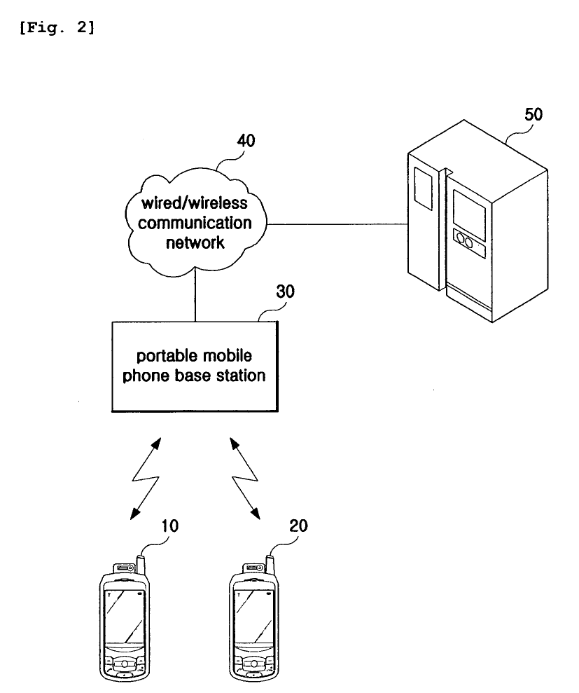

FIG. 2 illustrates the structure of a network to which a mobile communication terminal for providing a background picture during communication according to an embodiment of the present invention is applied.

As shown in FIG. 2, the network to which the mobile communication terminal according to the present invention is applied can be constructed by connecting a plurality of mobile communication terminals 10 and 20 according to the present invention to a background picture service provision device 50 that provides a variety of background picture files through a wired/wireless communication network 40. Reference numeral 30 denotes a mobile phone base station. For example, the mobile communication terminal 10 is a wireless communication device with portability and mobility and includes any type of handheld wireless communication device which uses a base station or a switching center, such as a Personal Communication System (PCS), a Global System for Mobile communications (GSM), a Personal Digital Cellular (PDC), a Personal Handyphone System (PHS), a Personal Digital Assistant (PDA), an International Mobile Telecommunication (IMT)-2000 communication terminal, and a smart phone.

The background picture service provision device 50 includes a database (not shown) that stores a variety of background picture files according to the present invention. Preferably, the database includes a user information DB that stores user information of each user required to access the background picture service provision device 50, a background picture list DB that stores a list of background pictures provided to the mobile communication terminals 10 and 20 of the users, and a background picture DB that stores a variety of background picture files.

The variety of background picture files provided by the background picture service provision device 50 basically includes a variety of video components suitable for each type of mobile communication terminals and may further include audio components used for background music. The users can download background picture files by accessing the background picture service provision device 50 through an Internet Service Provider (ISP) of the wired/wireless communication network 40 using their mobile communication terminals 10 and 20.

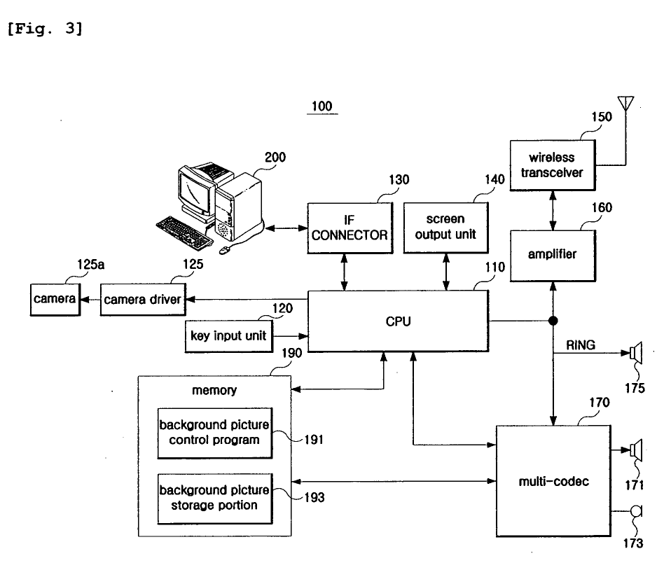

FIG. 3 is an electrical block diagram of a mobile communication terminal that can be applied to the present invention.

As shown in FIG. 3, the mobile communication terminal 100 that can be applied to the present invention includes a central processing unit (CPU) 110, a user input unit 120, an IF connector 130, a screen output unit 140, a wireless transceiver 150, an amplifier 160, a multi-codec 170, a memory 190, a phone receiver 171, a speaker 175, and a microphone 173.

The following description will first focus on operations of the mobile communication terminal when it desires to transmit a background signal or picture. The CPU 110 controls the overall operation of the mobile communication terminal 100 and is preferably implemented using a Micro Processing Unit (MPU). The CPU 110 first checks whether or not the mobile communication terminal is in communication. If the mobile communication terminal is not in communication, i.e., if it is in standby mode, the CPU 110 performs a general control operation since its state is not associated with using a background signal or picture. If the mobile communication terminal receives a user input while in communication, the CPU 110 detects the user input signal and determines whether or not it is a signal associated with controlling a background signal or picture. If the user input is associated with enabling and transmitting a background signal or picture function, the CPU 110 selects background signal or picture data previously stored in the memory 190, corresponding to the user input, and converts it through the multi-codec 170. Thereafter, the CPU 110 mixes the background signal or picture with a communication voice at an audio data mixing unit and transmits the mixed signal to a counterpart terminal through the wireless transceiver 150. At the same time, the CPU 110 causes the background signal or picture transmitted to the counterpart terminal to be reproduced at the mobile communication terminal by outputting it through the screen output unit 140 and/or an audio output unit including the phone receiver 171 and the speaker 175 so that both the terminals communicate with each other using the same background signal or picture. The counterpart terminal receives and reproduces combined data of its counterpart's communication voice and the background signal or picture.

If the user input is associated with deactivating a background signal or picture, the CPU 110 terminates all operations associated with transmitting the background signal or picture and transmits only the communication voice to the counterpart terminal so as to perform general voice communication without a background signal or picture.

If the user input is associated with changing a background signal or picture, the CPU 110 terminates all operations associated with transmission of the background signal or picture that is currently transmitted and selects and extracts a background signal or picture corresponding to the new user input from the memory. The CPU 110 then performs the same operations as described above when transmitting the background signal or picture to allow the users to perform communication with each other through the new background signal or picture.

Although the user input unit 120 generally includes a keypad including number keys and a variety of function keys, it may also include a plurality of keys/buttons that are identified with images such as icons on an input unit such as a touch panel. The user input unit may also be designed to receive, through character recognition, a signal that the user has input using a pen on a touch panel. A detailed description of the configuration of the user input unit is omitted here since it is constructed using a general keypad or touch panel.

A user input through the user input unit 120 allows the CPU 110 to perform a corresponding control operation, for example, an operation for reproducing, changing, or deactivating a background picture or an operation for controlling the volume level of its audio component.

User inputs are stored in the memory in association with respective background signals or pictures. Specific user inputs may be set to be associated with specific functions through a background picture control program. For example, pressing a sharp “#” button may be set to increase the volume level of audio included in the background picture and pressing a star “*” button may be set to decrease the volume level.

In another embodiment, a first specific user input (for example, a “#” button input) is set to be assigned a function to change to a next-ranked background signal or picture in a list of ranked background signals or pictures and a second specific user input (for example, a “*” button input) is set to be assigned a function to change to a previous-ranked background signal or picture in the list of background signals or pictures.

The IF connector 130 is a connector used for connection to an external device for handsfree, software update, or wireless data communication or data link purposes. In the present invention, the terminal may be connected to another device such as a PC 200 or a PDA through the IF connector 130 to store background pictures in the terminal 100.

The screen output unit 140 may be implemented using a liquid crystal display element to display a variety of states of the mobile communication terminal. The screen output unit 140 displays a variety of screens for using background pictures according to the present invention such as a screen for setting a background picture, a screen for previewing a background picture, a screen for deleting a background picture, and a screen for downloading a background picture. Through content displayed on the screen output unit 140, the user can perform operations for setting, deleting, previewing, and downloading a background picture according to the present invention. The screen output unit 140 is integrated with the audio output unit including the phone receiver 171 and the speaker 175 to constitute an output unit.

The wireless transceiver 150 transfers a signal received through an antenna to the amplifier 160. The wireless transceiver 150 also receives a background picture and audio data from the amplifier 160 and transmits it through the antenna.

The memory 190 is constructed to basically store an address book, telephone numbers, and ringtones. The memory 190 includes a background picture control program 191 and a background picture storage portion 193. The background picture control program 191 includes a plurality of command routines corresponding respectively to a plurality of user inputs received during communication. The background picture storage portion 193 stores background picture files. Background pictures stored in the memory 190 are updated by downloading updates from the background picture service provision device 50 that provides background picture files through a wireless data communication network. The background pictures may also be updated by downloading updates from another medium of the personal computer 200 or PDA that is coupled to the terminal through the IF connector 130. The background picture control program 191 is basically stored in the memory of the mobile communication terminal 100 or may be stored in another storage element installed in the mobile communication terminal 100. In this case, using the installed background picture control program 191, the mobile communication terminal 100 can selectively use a background picture stored in it or a background picture downloaded from the service provision device 50.

Although the background pictures or signals may be stored in association with user inputs (for example, key/button inputs), they may be set on a communication group basis or on a communication counterpart phone number basis and then may be stored as a database in the memory. In this case, when transmitting a background sound, the CPU 110 determines a phone number of the communication counterpart or a previously stored communication group of the communication counterpart and automatically reproduces a corresponding background picture or signal stored in the memory without waiting for a key/button input from the user.

The multi-codec 170 converts an analog audio signal input from the microphone 173 into a digital signal and outputs it to the amplifier 160, converts a digital audio signal input from the amplifier 160 into an analog signal and outputs it to the speaker 175 and the phone receiver 171, or synthesizes a user voice signal input through the microphone 173 and a background picture into a single signal and transmits it to a recipient through the wireless transceiver 150.

The mixing unit (not shown) mixes a communication voice signal with a sound source signal included in the background picture and can be constructed using a mixer that is used for general audio processing. When the background picture is a still picture, the mixing unit is constructed to mix the communication voice with separate background sound data since no sound source signal is included in the background picture.

A camera 125a captures and outputs a still or motion picture. A camera driver 125 drives the camera 125a according to control of the CPU 110 so as to store the captured picture in the memory 190. In the case where the camera 125a is installed on the terminal of the user, not only the background picture provided from the service provision device 50 but also the still and motion picture that the user has captured using the camera 125a can be used as the communication background picture.

When a communication path has been connected and the user desires to reproduce a background picture matching a calling or called phone number, the CPU 110 of the user terminal reconstructs a corresponding compressed background picture, stored in the background picture storage portion 193 in the memory 190, into video and audio components of the background picture through the multi-codec 170. The CPU 110 outputs the video component to the screen output unit 140 and outputs the audio component through the audio output unit such as the phone receiver 171 and the speaker 175. When the user desires to transmit the matching background picture to the counterpart mobile communication terminal, the CPU 110 amplifies a corresponding compressed background picture stored in the background picture storage portion 193, without decompression, together with a voice signal of the user and then transmits the amplified picture and signal to the counterpart terminal through the wireless transceiver 150.

When a communication path has been connected and a background picture matching a calling or called phone number has been transmitted from the counterpart mobile communication terminal through the communication path, the CPU 110 of the user terminal reconstructs video and audio components from the transmitted compressed background picture through the multi-codec 170 and outputs the video component to the screen output unit 140 and the audio component through the audio output unit.

When calling and called mobile communication terminals, which originate and receive a call, respectively, are all capable of providing a background signal or picture, both the terminals may transmit their background signals or pictures. In this case, a background signal or picture transmitted from one of the two terminals, which is determined according to their priority levels, is only allowed to be used for communication.

In an embodiment of the present invention, first, the priority level of a mobile communication terminal can be determined depending on whether or not it is a calling or called terminal. For example, the higher priority level is given to a calling terminal and the lower priority level is given to a called terminal. Accordingly, the calling terminal transmits a background signal or picture regardless of the state of the called terminal. On the other hand, the called terminal first detects whether or not any background signal or picture has been transmitted from the calling terminal and transmits a background signal or picture of the called terminal only if no background signal or picture has been received from the calling terminal. If the calling terminal starts transmitting a background signal or picture even while the called terminal is transmitting a background signal or picture, the called terminal detects the transmission from the calling terminal and stops its background signal or picture transmission operation and reproduces the background signal or picture transmitted from the calling terminal.

To accomplish this embodiment, the calling terminal that desires to notifies a base station or a switching center of start of background signal or picture transmission by transmitting a background signal or picture transmission start signal to the base station or switching center through an uplink control signal and the transmission start notification signal is then transmitted to the called terminal so as to disable a background signal or picture transmission function of the called terminal. Thereafter upon receiving a background signal or picture transmission stop signal from the calling terminal, the called terminal again enables its background signal or picture transmission function.

In another embodiment of the present invention, each of the calling and called terminals first check whether or not its counterpart has not transmitted any background signal or picture. Each of the calling and called terminals is allowed to transmit its background signal or picture only if its counterpart has not transmitted any background signal or picture and is not allowed to transmit its background signal or picture until a previously transmitted background signal or picture is stopped or terminated.

To accomplish this embodiment, when each of the calling and called terminals desires to transmit a background signal or picture, the terminal transmits an uplink control signal including a background signal or picture transmission start signal to the counterpart terminal through the switching center. In addition, when each of the calling and called terminals has received a background signal or picture transmission start signal of its counterpart terminal through a downlink control signal from the base station, the terminal is not allowed to transmit its background signal or picture until it receives a background signal or picture of the counterpart terminal.

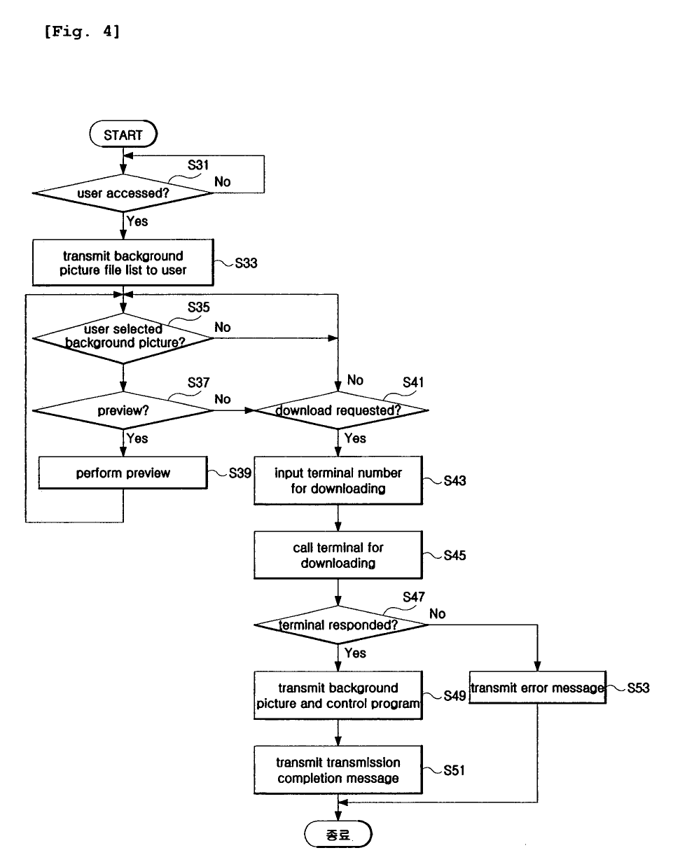

FIG. 4 is a flow chart of a method for downloading a communication background picture according to an embodiment of the present invention.

First, at step S31, the background picture service provision device 50 determines whether or not any user has accessed the device 50 to download a background picture.

If it is determined at step S31 that any user has accessed, the device 50 proceeds to step S33 to transmit a list of background picture files stored in a database to a terminal of the user.

Then, at step S35, the device 50 determines whether or not the user terminal has selected a specific background picture file. If any specific background picture file has been selected, the device 50 proceeds to step S37 to determine whether or not the user terminal has made a preview request for the background picture file.

If it is determined at step S37 that a preview request has been made, the device 50 proceeds to step S39 to perform an operation for previewing the background picture file.

If it is determined at step S35 that no specific background picture file has been selected or if it is determined at step S37 that no preview request has been made, the device 50 proceeds to step S41 to determine whether or not the user terminal has made a download request.

If it is determined at step S41 that no download request has been made, the background picture service provision device 50 repeats the process of step S35. If a download request has been made, the device 50 proceeds to step S43 to allow the user to input the phone number of the terminal to which a background picture is to be transmitted.

Then, at step S45, the device 50 calls the user terminal to which a background picture is to be transmitted and proceeds to step S47 to determine whether or not the user terminal has made a response.

If it is determined at step S47 that the user terminal has made no response, the background picture service provision device 50 proceeds to step S53 to transmit an error message. If the user terminal has made a response, the device 50 proceeds to step S49 to transmit a background picture and a background picture control program to the user terminal. Here, the device 50 may search for any background picture control program installed on the mobile communication terminal to which the background picture is to be transmitted and may transmit a background picture control program to the mobile communication terminal according to selection of the user. In this case, the device 50 automatically selects a background picture control program according to the type of the mobile communication terminal and transmits the program to the terminal to be installed on it.

Then, at step S51, the device 50 terminates the entire procedure after transmitting a message, indicating completion of the transmission of the background picture and the background picture control program, to the user terminal. The above method may omit steps S37 and S39 and may also perform step S41 immediately at step S35.

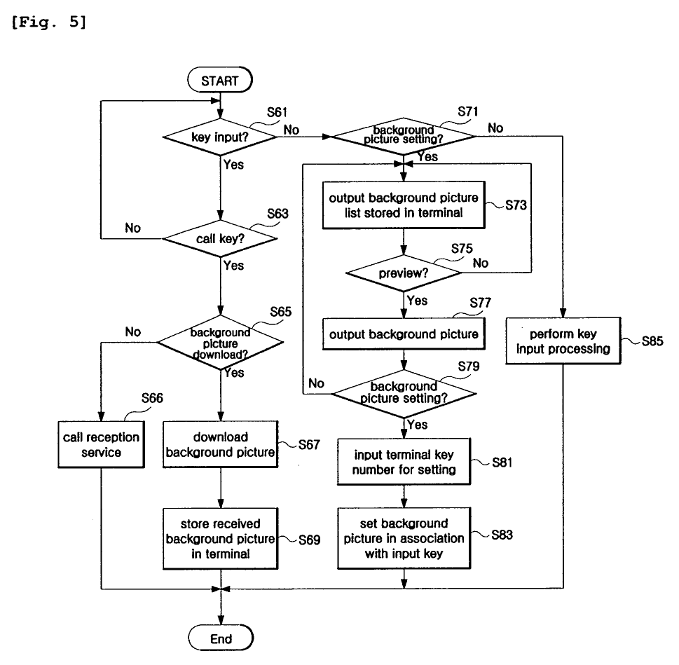

FIG. 5 is a flow chart of a method for setting a background picture in the mobile communication terminal according to an embodiment of the present invention.

At step S61, the CPU 110 of the mobile communication terminal determines whether or not a user input for performing a specific command has been received. If a user input has been received, the CPU 110 proceeds to step S63 to determine whether or not the user input corresponds to a call key used to receive a call and to establish a communication.

If it is determined at step S63 that the user input does not correspond to the call key, the CPU 110 returns to step S31. If the user input corresponds to the call key, the CPU 110 proceeds to step S65 to determine whether or not the key input is to download a background picture file from the service provision device 50.

If it is determined at step S65 that the key input is not to download a background picture file, the CPU 110 proceeds to step S66 to perform a general call reception service. If the user key is to download a background picture file, the CPU 110 downloads and stores the background picture file in the user terminal.

On the other hand, if it is determined at step S61 that a user input for performing a specific command has not been received, the CPU 110 proceeds to step S71 to determine whether or not a specific button corresponding to background picture setting has been received from the user.

If it is determined at step S71 that a specific button corresponding to background picture setting has not been received, the CPU 110 proceeds to step S85 to perform a command corresponding to the user input. If a specific button corresponding to background picture setting has been received, the CPU 110 proceeds to step S73 to display a list of background picture files stored in the user terminal on the screen output unit 140.

Then, at step S75, the CPU 110 determines whether or not the user has made a preview request. If the user has not made a preview request, the CPU 110 returns to step S73, otherwise it proceeds to step S77 to perform an operation for previewing the background picture.

Then, at step S79, the CPU 110 determines whether or not a background picture setting request has been made. If no background picture setting request has been made, the CPU 110 returns to step S73, otherwise it proceeds to step S81 to receive a terminal key number for setting from the user. The terminal key number received from the user corresponds to one of specific keys/buttons (for example, #1 to #9 keys/buttons) preset in the terminal. Background pictures are preset in association with the specific keys/buttons. A background picture preset on a key/button may be reproduced and deactivated and the volume level of its audio component may be controlled by operating the key/button. For example, a next-ranked background picture may be reproduced by pressing the first dial button of the mobile communication terminal and a previous-ranked background picture may be reproduced by pressing the second dial button. This key/button setting is preferably performed with the background picture control program 191 that is designed to detect a user input from the user while the mobile communication terminal is in communication and to perform a series of commands set in association with each key/button.

Returning to FIG. 5, finally, the CPU 110 sets and stores the background picture in association with the key number received from the user at step S83.

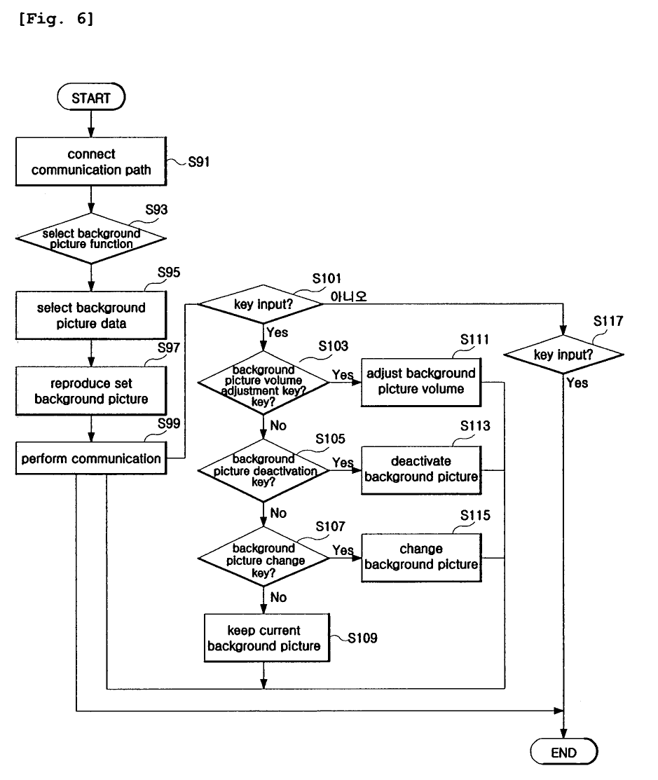

FIG. 6 is a flow chart of a procedure for communication using a background picture according to an embodiment of the present invention.

At step S91, a communication path is connected and the CPU 110 enters a standby mode in which it waits for transmission and reproduction of a background picture.

At step S93, the CPU 110 checks whether or not a user input has been received and checks whether or not the user input is associated with enabling and controlling a background picture function. If the user input is not associated with a background picture, the terminal is kept in standby mode. If the user input is associated with a background picture, the CPU 110 enables background picture control through the background picture control program and waits for an input for background picture selection from the user. The selection of the background picture function may be implemented by display of a menu on the screen output unit 140 of the terminal and may also be implemented by a preset key, a character input, or the like.

Once the background picture function is selected and enabled, the CPU 110 allows background picture data to be selected at step S95. Here, the user can select specific background picture data through a displayed menu screen and may also select a background picture directly by inputting a memorized shortcut key. The user may also be allowed to immediately transmit a default background picture preset on a phone number basis or on a recipient group basis. In this case, the background picture data selection process may be omitted.

If a background picture has been selected at step S95 or if a preset background picture is present, the CPU 110 proceeds to step S97 to perform a background picture set in association with the phone number of the recipient. Here, the user may be allowed to transmit the background picture data simultaneously with the selection of the background picture data and may also be allowed to reproduce a background picture by pressing a specific key/button preset in the terminal.

Returning to FIG. 6, at step S99, the CPU 110 transmits a variety of communication background pictures together with the user's voice to the recipient to perform communication with the recipient.

At step S101, the CPU 110 determines whether or not a specific user input has been received from the user. If the specific-user input has been received, the CPU 110 proceeds to step S103 to determine whether or not the user input corresponds to a volume level adjustment key for the audio component of the background picture.

If it is determined at step S103 that the user input corresponds to a volume level adjustment key, the CPU 110 proceeds to step S111 to adjust the volume of the audio component of the background picture. The volume level adjustment key is a specific key/button preset for adjusting the volume level of the audio component of the background picture. For example, the sharp “#” button may be set to increase the volume level when pressed and the star “*” button may be set to decrease the volume level when pressed.

Returning to FIG. 6, if it is determined at step S103 that the user input does not correspond to the volume level adjustment key, the CPU 110 proceeds to step S105 to determine whether or not it corresponds to a background picture deactivation key. If the user input corresponds to the background picture deactivation key, the CPU 110 proceeds to step S113 to deactivate the reproduction of the background picture, otherwise it proceeds to step S107 to determine whether or not it corresponds to a background picture change key.

If it is determined at step S107 that the user input corresponds to the background picture change key, the CPU 110 proceeds to step S115 to change the background picture, otherwise it proceeds to step S109 to maintain the reproduction of the current background picture.

On the other hand, the background picture control program enables the background picture function and keeps it active until the user cancels the selection of the background picture function or until the communication is terminated. This makes it easier to control (for example, change) the background picture.

For example, when the user desires to select background picture transmission and reproduction, the user presses a “**” key. Then, when the user desires to reproduce a “3rd” picture as background picture data, the user needs to press a key sequence “**3”. Thereafter, the user can change the background picture data to “5th” background picture data by pressing only one key “5” without pressing the “*” key. Accordingly, when the background picture function has been enabled or performed, the user can perform control of the background picture such as change of the background picture control by operating or inputting only one key.

The background picture control program according to the present invention is developed using a development tool provided by a terminal manufacturer or a communication company. The development tool provides a function to identify a terminal key input or a function to reproduce a media file such as a motion picture or the like. Using these functions can identify a key pressed on the terminal.

As is apparent from the above description, the method for providing a background picture during communication according to the embodiments of the present invention has a variety of features and advantages. For example, the method according to the present invention provides environments in which users can download a communication background picture and a background picture control program through a wired/wireless communication network and then store them in their mobile terminals. When performing communication, a calling user can also transmit a background picture stored in their terminal together with their voice to a called user. The user can also change the communication background picture during communication. These features significantly increase the satisfaction of users of mobile communication terminals.

In addition, communication background pictures are set in association with specific buttons on the mobile communication terminal. The mobile communication terminal is designed such that, when its communication path has been established, pressing a specific key on the terminal can reproduce and deactivate a background picture corresponding to the specific key and also can control the volume level of the audio component of the background picture. This makes it possible to provide a more convenient and individual communication background picture service to the user.

When both the calling and called terminals have a background picture transmission function, one of the background signals or pictures of the calling and called terminals is selected according to their preset priority levels, thereby allowing the calling and called users to perform communication using the same background signal or picture.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A mobile communication terminal for providing a background picture during communication, the terminal comprising:
a memory for storing at least one background picture, each including a picture signal corresponding to a respective user input;
a multi-codec for converting the background picture and a communication voice;
a mixing unit for mixing the background picture with the communication voice;
a wireless transceiver for wirelessly transmitting the mixed background picture and communication voice;
an output unit for outputting the mixed background picture and communication voice; and
a central processing unit for selecting, controlling, and transmitting a background signal according to the user input.

2. The mobile communication terminal according to claim 1, wherein the central processing unit performs at least one of a function to transmit a background picture, a function to change a background picture, a function to stop transmitting a background picture, and a function to control volume level of a background picture according to a user input from a user.

3. The mobile communication terminal according to claim 2, wherein the user input is performed using at least one of an input method using a key on a keypad, an input method using an icon on a touch screen, and an input method using character recognition on a touch screen.

4. The mobile communication terminal according to claim 3, wherein the background picture is downloaded from a background picture service provision device through a wired/wireless communication network and is then set and stored in association with at least one user input.

5. The mobile communication terminal according to claim 4, wherein the background picture is stored in association with a user input set on a communication group basis or a phone number basis.

6. The mobile communication terminal according to claim 5, further comprising a camera for capturing and storing a still or motion picture,
wherein the background picture is captured by the camera.

7. The mobile communication terminal according to claim 6, wherein, when the mobile communication terminal receives a first user input, a next-ranked background picture is selected as a background picture to be transmitted and reproduced and, when the mobile communication terminal receives a second user input, a previous-ranked background picture is selected as a background picture to be transmitted and reproduced.

8. A mobile communication terminal for providing a background signal during communication, the terminal comprising:
a memory for storing a background signal including at least one sound source and/or picture signal, each corresponding to a respective user input;
a multi-codec for converting the background signal and a communication voice;
a mixing unit for mixing the background signal with the communication voice;
a wireless transceiver for wirelessly transmitting the mixed background signal and communication voice;
an output unit for outputting the mixed background signal and communication voice; and
a central processing unit for selecting, controlling, and transmitting a background signal according to the user input, wherein the central processing unit determines whether or not to transmit and/or output the background signal taking into consideration a preset priority level of the mobile communication terminal.

9. The mobile communication terminal according to claim 8, wherein the priority level of the mobile communication terminal is determined according to whether the mobile communication terminal is a calling or called terminal, or is determined by determining whether or not a counterpart terminal has transmitted a background signal.

10. The mobile communication terminal according to claim 9, wherein the central processing unit performs at least one of a function to transmit a background signal, a function to change a background signal, a function to stop transmitting a background signal, and a function to control volume level of a background signal according to a user input.

11. The mobile communication terminal according to claim 10, wherein the background signal is a background picture signal and the user input is performed using at least one of an input method using a key on a keypad, an input method using an icon on a touch screen, an input method using character recognition on a touch screen, and an input method using a voice command.

12. The mobile communication terminal according to claim 11, wherein the background picture is downloaded from a background picture service provision device and is then set and stored in association with a respective user input.

13. The mobile communication terminal according to claim 12, wherein the mixing unit mixes the background picture and communication voice with separate background sound data according to control of the central processing unit.

14. The mobile communication terminal according to claim 13, further comprising a camera for capturing and storing a still or motion picture,
wherein the background picture is captured by the camera.

15. The mobile communication terminal according to claim 14, wherein, when the mobile communication terminal receives a first user input, a next-ranked background picture is selected as a background picture to be transmitted and reproduced and, when the mobile communication terminal receives a second user input, a previous-ranked background picture is selected as a background picture to be transmitted and reproduced.
